(19) United States
(12) Patent Application Publication
(10) Pub. No.: US 2015/0221337 A1
(43) Pub. Date: Aug. 6, 2015

(54) Secondary Video Generation Method

(71) Applicant: Jong Wan KIM, Roswell, GA (US)

(72) Inventor: Jong Wan KIM, Roswell, GA (US)

(21) Appl. No.: 14/246,387

(22) Filed: Apr. 7, 2014

Related U.S. Application Data
(60) Provisional application No. 61/934,956, filed on Feb. 3, 2014.

(51) Int. Cl. G11B 27/031; G11B 27/30; G11B 27/00; H04N 5/77; G11B 27/06

(52) U.S. Cl. CPC G11B 27/031; H04N 5/772; G11B 27/06; G11B 27/002; G11B 27/3081

(57) ABSTRACT

A method of generating a secondary video recording containing all interesting or notable moments of a particular event created simultaneously with a main video recording of the particular event. The method of generating a secondary video recording accomplishes this by receiving and identifying a user input as a means of identifying an interesting or notable moment. After identifying the user input an interval of the main video recording is calculated spanning the moments immediately prior and immediately following the instance when the user input was received. The method then stores the interval in a tempfile and continuously aggregates additional intervals within the same tempfile. Upon the conclusion of the main video recording, the method converts the tempfile into a secondary video recording containing the plurality of interesting and notable moments arranged in chronological order.

The current application claims a priority to the U.S. Provisional Patent application Ser. No. 61/934,956 filed on Feb. 3, 2014.

### FIELD OF THE INVENTION

The present invention relates generally to a method for a video recording system, more specifically to a method of generating an additional video recording containing a plurality of segments from a main video recording.

### BACKGROUND OF THE INVENTION

A user operates a video recording system to create a video recording of a particular event. The video recording of the particular event preserves audio and visual data in a viewable format allowing the user to revisit the particular event at a later time. Although the duration of a particular event may vary, many particular events are filled with mundane or interesting moments between interesting or notable instances. While many video recording systems allow a user to pause and restart the video recording process to create a shorter video recording containing only interesting or notable instances of a particular event, the user runs the risk of missing part of or the entirety of the interesting or notable instance. In order to ensure that all interesting instances are captured, a user continuously records the particular event in its entirety. Although modern video recording system can accommodate large video recording, a user would still have to watch the entirety of the video recording to view each interesting or notable instance of the particular event. While video editing software exists allowing a user to extract and consolidate interesting instance of a video recording. Video editing software require the completed video recording, at least a modest degree of familiarity with the software, and additional time to create a more consolidated video recording.

It is therefore the object of the present invention to provide a method of generating a secondary video recording containing all interesting or notable moments of a particular event created simultaneously with a main video recording of the particular event. The present invention accomplishes this by receiving and identifying a user input as a means of identifying an interesting or notable moment. After identifying the user input an interval of the main video recording is calculated spanning the moments immediately prior and immediately following the instance when the user input was received. The method then stores the interval in a tempfile and continuously aggregates additional intervals within the same tempfile. Upon the conclusion of the main video recording, the method converts the tempfile into a secondary video recording containing the plurality of interesting and notable moments arranged in chronological order.

### BRIEF DESCRIPTIONS OF THE DRAWINGS

FIG. 1 is a representative illustration displaying a general overview of the secondary video generation method as per the current embodiment of the present invention.

FIG. 2 is a flow chart diagram displaying the process overview of the secondary video generation method as per the current embodiment of the present invention.

FIG. 3 is a flow chart diagram displaying the steps associated with receiving a segment identifying input as per the current embodiment of the present invention.

FIG. 4 is a flow chart diagram displaying the steps associated with generating appended secondary segments as per the current embodiment of the present invention.

### DETAIL DESCRIPTIONS OF THE INVENTION

All illustrations of the drawings are for the purpose of describing selected versions of the present invention and are not intended to limit the scope of the present invention.

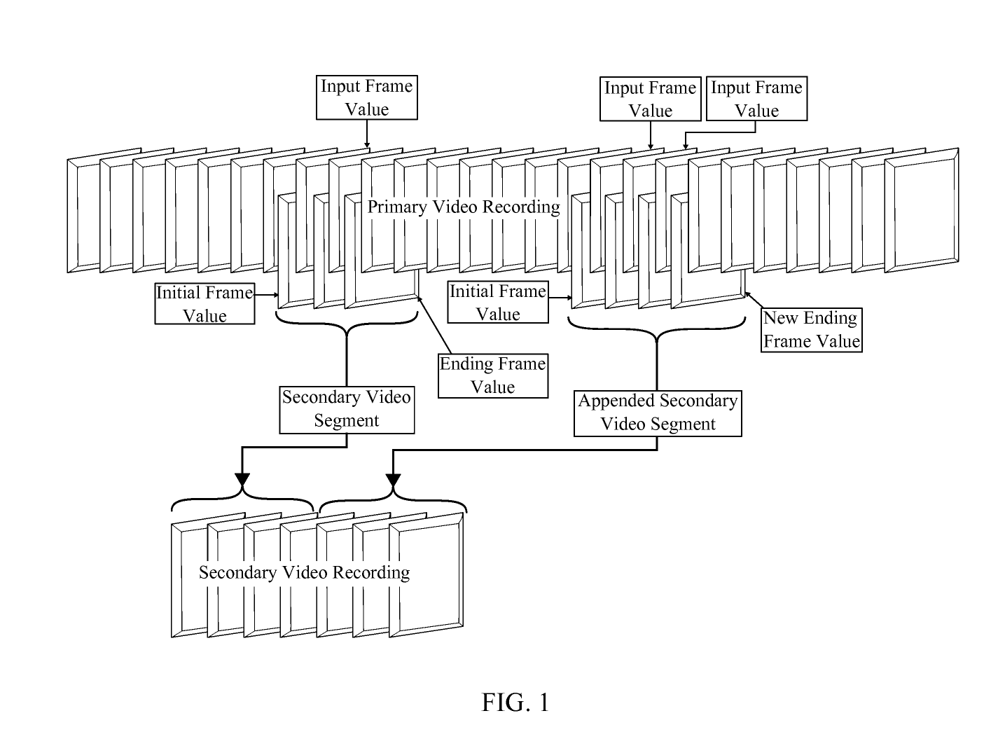

Referencing FIG. 1, the present invention is a secondary video generation method that enables a user to assign importance to particular segments of a primary video recording in order to aggregate the particular segments into a secondary video recording. The secondary video generation method occurs while the video recording system is capturing a primary video recording. In the current embodiment of the present invention, the secondary video generation method is a computer executable instruction comprising several key steps, that include generating a secondary video tempfile, receiving a plurality of segment identifying inputs, calculating an initial frame value, calculating an ending frame value, aggregating a plurality of secondary video segments in the secondary video tempfile, and generating a secondary video recording from the secondary video segments.

In the current embodiment of the present invention, the secondary video generation method is provided with an active video recording system. The active video recording system is a system that is actively capturing a primary video recording. The primary video recording is a stream of information that contains both audio and visual data. The primary video recording is captured by the video recording system at a particular frame rate. The frame rate is the frequency at which the video recording system records unique consecutive images of the primary video recording. Each frame of the primary video recording contains both audio and visual data. The primary video recording comprises a plurality of frames. Each frame of the plurality of frames is consecutively assigned a frame value. The assignation of frame values to the plurality of frames provides the secondary video generation method with a continuous variable for denoting past, present, and future instances of a primary video recording being actively captured by the video capturing system.

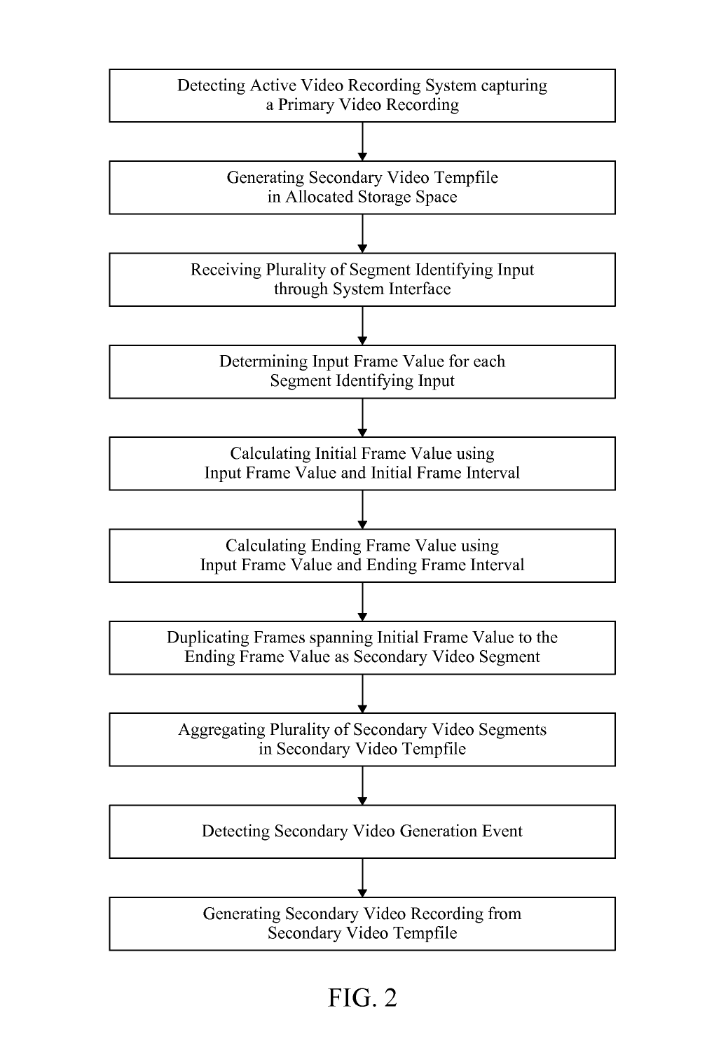

Referencing FIG. 2, in the current embodiment of the present invention the secondary video generation method is provided with a system interface. The system interface is a component of an active video recording system that serves as the interaction point for a user. In the current embodiment of the present invention, the system interface receives a user input corresponding to an event during the primary video recording. The system interface may be provided as a single component or a collection of components and may comprise hardware input means or software input means, as well as combinations thereof. The system interface may be provided with a means of receiving inputs or with a means of displaying output and receiving inputs. Additionally the system interface may be provided as an interaction point for modify setting associated with the secondary video generation method such as but not limited to interval length and storage locations.

Referencing FIG. 1 and FIG. 2, the, the secondary video generation method is a computer executable instruction set carried out by a processor or similar component that is communicably coupled to the active video recording system. The initiation of the secondary video generation method commences upon the detection of an active video recording system. The active video recording system is detected upon capture initiation of the primary video recording. The secondary video generation method is configured to await the activation of video recording system and detects the system recognizable functions or events that indicate the capturing of the primary video recording. Alternatively, the secondary video generation method could be provided with a toggled activity state, where the secondary video generation method may require user activation in order prior to detecting an active video recording system. In the aforementioned embodiment, the secondary video generation method is provided in a binary state configuration that is toggled by a user. The secondary video generation method could be active prior to the initiation of the active video recording system in order to detect the capture initiation of the primary video recording or that secondary video generation method could be toggled by a user to an active state following the activation of the video recording system.

Referencing FIG. 2, the secondary video generation method creates a secondary video tempfile upon detecting the active video recording system. The secondary video tempfile collects duplicate frames of the primary video recording. The duplicate frames of the primary video recording contain audio and visual data. The duplicate frames of the primary video recording are created by the secondary video generation method upon receiving a particular user input. The secondary video generation method duplicates frames of the primary video recording and stores them in the secondary video tempfile as secondary video segments. A plurality of secondary video segments are collected in the secondary video tempfile. The plurality of secondary video segments are later combined to create the secondary video recording. Due to the potential storage requirements of the plurality of secondary video segments, the secondary video tempfile is allocated storage space. The allocated storage space ensures sufficient storage capacity for the creation of the secondary video recording. Upon creating the secondary video tempfile, the secondary video generation method awaits a user input to create a plurality of secondary video segments.

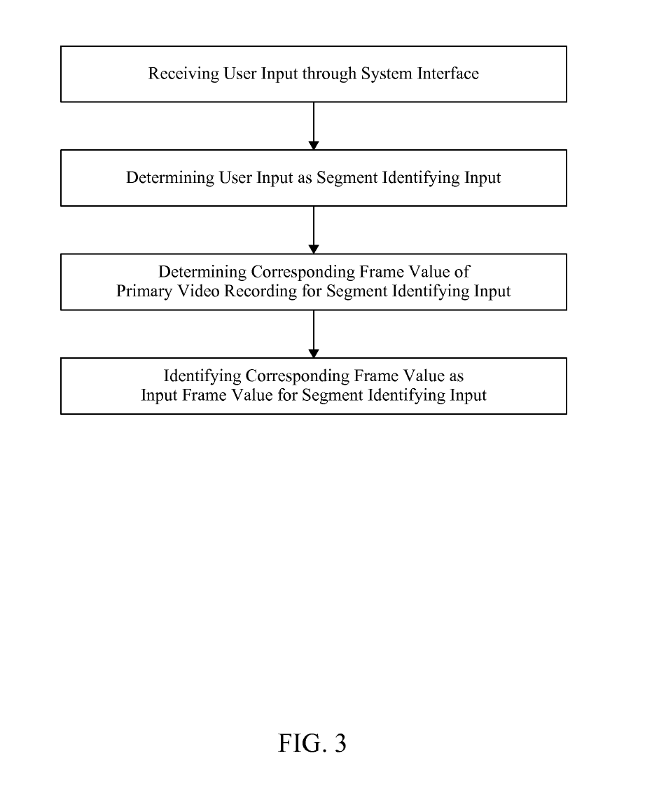

Referencing FIG. 3, the secondary video generation method receives a plurality of segment identifying inputs through the system interface. The system interface is communicably coupled to the active video recording system. The system interface receives a plurality of user inputs. The secondary video generation method determines a user input is a segment identifying input through differentiation. A segment identifying input is a particular user input entered through the system interface. The segment identifying input associates an instance in the primary video recording with an event. The associated instance in the primary video recording is utilized by the secondary video generation method to create a secondary video segment. The secondary video generation method determines a corresponding frame value of the primary video recording for the segment identifying input. The primary video recording comprises a plurality of frames with consecutively numbered frame values. The segment identifying input is received at an instance that corresponds to a particular frame value of the primary video recording. The secondary video generation method determines the corresponding frame value of the primary video recording and identifies it as an input frame value. The input frame value is utilized by the secondary video generation method to calculate a particular interval of the primary video recording corresponding to a secondary video segment.

Referencing FIG. 2, the secondary video generation method calculates a particular interval of the primary video recording as a secondary video segment. Upon detecting that an input frame value has been identified, the secondary video generation method initiates calculations to determine the particular interval of the primary video recording associated with the input frame value. The particular interval of the primary video recording spans from an initial frame value to an ending frame value. The initial frame value and the ending frame value are calculated using the input frame value and predefined interval lengths.

Referencing FIG. 2, the initial frame value is calculated using an initial frame interval. The initial frame interval is a set distance in frames from the input frame value to a prior moment of the primary video recording. The prior moment of the primary video recording is determined as the initial frame value. The initial frame value provides a secondary video segment with an interval of frames that occurs prior to the instance when the segment identifying input was entered. Due to frame values being consecutively assigned and time dependent, the initial frame value is less than the input frame value. It should be noted that the initial frame interval is a predefined distance in frames utilized with each input frame value to calculate an initial frame value. It should be noted that in an additional embodiment, the input frame value may be interpreted the same as an initial frame value, if the initial frame interval contains no predefined value.

Referencing FIG. 2, the ending frame value is calculated using an ending frame interval. The ending frame interval is a set distance in frames from the input frame value to a later moment of the primary video recording. The later moment of the primary video recording is determined as the ending frame value. The ending frame value provides a secondary video segment with an interval of frames that occur following the instance when the segment identifying input was entered. Due to frame values being consecutively assigned and time dependent, the end frame value is greater than the input frame value. It should be noted that the ending frame interval is a predefined distance in frames utilized with each input frame value to calculate an ending frame value.

The secondary video generation method stores the secondary video segment in the secondary video tempfile. Upon calculating the initial frame value and the ending frame value, the secondary video generation method identifies the particular interval of the primary video recording spanning the initial frame value to the ending frame value as a secondary video segment. The secondary video generation method duplicates the frames of the primary video recording associated with the secondary video segment and stores the duplicated frames in the secondary video tempfile.

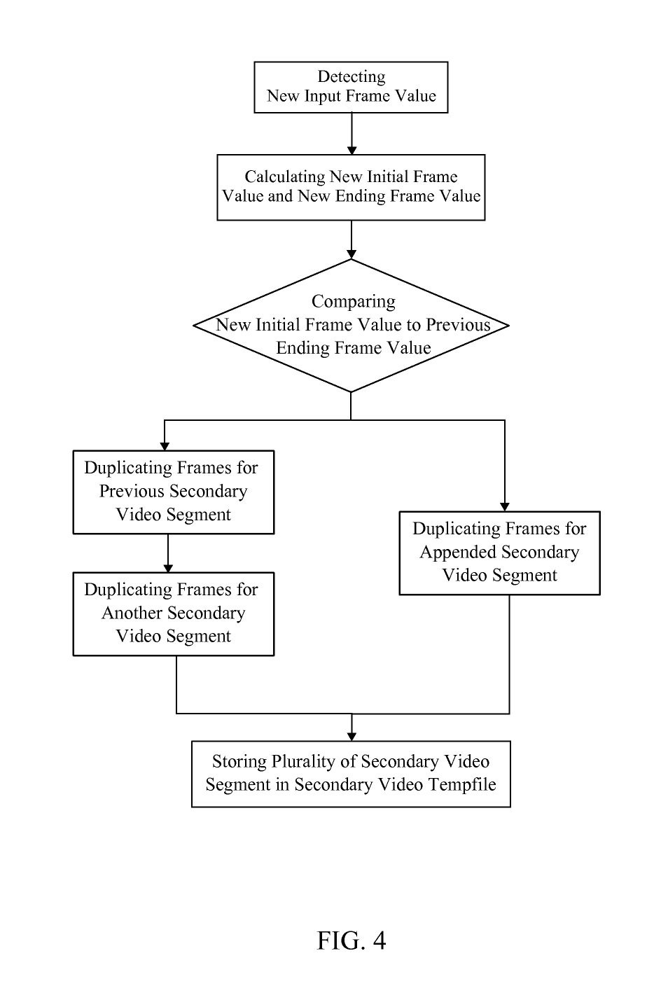

Referencing FIG. 4, the secondary video generation method compares interval values of successive segment identifying inputs in order to combine or differentiate secondary video segments. The secondary video generation method receives a plurality of segment identifying inputs. Each segment identifying input marks an input frame value of the primary video recording. The plurality of segment identifying inputs are received successively resulting in a segment identifying input becoming a previous segment identifying input upon receiving another segment identifying input, denoted as a new segment identifying input. The new segment identifying input marks a new input frame value of the primary video recording. The new input frame value is utilized to calculate a new initial frame value and a new ending frame value using the initial frame interval and the ending frame interval, respectively.

Referencing FIG. 4, the secondary video generation method receives a new segment identifying input that generates a particular interval that overlaps the particular interval of a previous segment identifying input. Instead of storing multiple secondary video segments containing similar duplicate frames, the secondary video generation method combines the particular intervals of a previous segment identifying input with the particular interval of the new segment identifying input to create an appended secondary video segment. The appended secondary video segment spans from an initial frame value of a previous segment identifying input to the new ending frame value of the new segment identifying input, if the new initial frame value is less than or equal to the ending frame value of a previous segment identifying input. The successive nature of receiving the plurality of segment identifying inputs provides the initial frame value utilized for the appended secondary video segment does not have to be the initial frame value of the segment identifying input immediately preceding the ending frame value of the new segment identifying input. Upon determining the initial frame value and the new ending frame value, the secondary video generation method duplicates the frames of the primary video recording associated with the appended secondary video segment and stores the duplicated frames in the secondary video tempfile.

Referencing FIG. 2 and FIG. 4, the secondary video generation method receives a plurality of segment identifying inputs successively. A new segment identifying input that generates a particular interval that does not overlap the particular interval of the previous segment identifying input results in separate secondary video segments stored in the secondary video tempfile. Upon receiving a new segment identifying input, the secondary video generation method calculates the new initial frame value and the new ending frame value using the new input frame value. The secondary video generation method compares the new initial frame value to the ending frame value of the previous segment identifying input. Secondary video segments are differentiated if the new initial frame value of the new segment identifying input is greater than the ending frame value of the previous segment identifying input. The previous segment identifying input is the segment identifying input immediately preceding the new segment identifying input. The secondary video generation method duplicates the frames of the primary video recording associated with the secondary video segment of the previous segment identifying input. The secondary video generation method then duplicates the frames of the primary video recording associated with the secondary video segment of the new segment identifying input. The secondary video generation method stores the duplicated frames in the secondary video tempfile in successive order. The secondary video segment corresponding to the previous segment identifying input is stored prior to the other secondary video segment corresponding to the new segment identifying input.

Referencing FIG. 2, the secondary video generation method aggregates the plurality of secondary video segments in the secondary video tempfile. The secondary video tempfile receives the duplicate frames of the primary video recording associated with a plurality of secondary video segments. The plurality of secondary video segments received by the secondary video tempfile include a plurality of appended secondary video segments. The plurality of secondary video segments are aggregated in the secondary video tempfile. The secondary video generation method arranges the plurality of secondary video segments within the secondary video tempfile by the order received in the secondary video tempfile. The plurality of secondary video segments are arranged in the secondary video tempfile in successive order. The arrangement of the plurality of secondary video segments in successive order facilitates the conversion of the secondary video tempfile into a secondary video recording.

Referencing FIG. 2, the secondary video generation method creates a secondary video recording from the secondary video tempfile. The secondary video generation method detects a secondary video generation event. The secondary video generation event signals to the secondary video generation method that the secondary video recording is ready to be generated from the secondary video tempfile. The secondary video generation event may be provided as a particular user input received through the system interface or a particular action of the video recording system. In the preferred embodiment of the present invention, the secondary video generation event is the completion of the primary video recording. The secondary video generation method detects the state change of the video recording system, where the video recording system goes from an active state to an inactive state. The active video recording system is a video recording system that is capturing a primary video recording. The completion of the primary video recording changes the state of the video recording system from an active state to an inactive state. The secondary video generation method identifies the state change as the secondary video generation event and begins the process to create the secondary video recording from the secondary video tempfile.

Referencing FIG. 2, the secondary video generation method closes the secondary video tempfile upon detecting the secondary video generation event. The secondary video tempfile contains a plurality of secondary video segments arranged in successive order. The secondary video tempfile is allocated an unspecific amount of storage space anticipating a large file size. Upon detecting the secondary video generation event, the secondary video generation method determines the cumulative size of the plurality of secondary video segments aggregated within the secondary video tempfile. The secondary video tempfile is closed by the secondary video generation method in order to be converted into the secondary video recording. The conversion of the secondary video tempfile into the secondary video recording converts the plurality of secondary video segments into a user viewable format. It should be noted that the conversion process of the secondary video tempfile may include an encoding process.

In an embodiment of the invention, the secondary video tempfile collects a plurality of value sets. The secondary video generation method marks an input frame value for each segment identifying input. The secondary video generation method calculates both the initial frame value and the ending frame value. Instead of duplicating the frames of the primary video recording following the determination of the initial frame value and the ending frame value, the aforementioned embodiment stores the initial frame value and the ending frame value as a particular value set in the secondary video tempfile. Upon completion of the primary video recording, the secondary video generation method utilizes the plurality of value sets as an instruction set for identifying particular intervals of the primary video recording and then duplicating the frames of the particular interval to the secondary video tempfile. The duplicated frames are aggregated in the secondary video tempfile as secondary video segments that are utilized in the generation of the secondary video recording.

The secondary video generation method is provided as executable instructions executed on a video recording system. The secondary video generation method may be provided as a built in feature of a video recording device's original manufacturer software. Alternatively, the secondary video generation software may be provided as a downloadable application.

The secondary video generation method creates video segments from an in progress video recording. A user interacts with the secondary video generation method by touching a touch screen interface corresponding to a virtual button or button(s) or by interacting with a physical button connected to an active video recording system. The secondary video generation method combines the video segments into a secondary video recording.

The user can generate the additional video segments by clicking the virtual icon(s) on a touch screen or physical button(s) connected to the device(s) other than stop, resume, pause functions while recording the event(s). The additional video segments contain audio and visual data before and after the user interaction. The user interaction is received at a particular instance that is utilized to calculate an interval of the video segment. The interval of the video segment spans from a moment prior to the user interaction to a moment following a user interaction. For instance, if the user interaction is received at 0:40, the interval of the video segment may span from 0:30 to 0:55.

Similar to the general process of recording with the device(s), an additional temp file is created for the secondary video recording. The additional tempfile is created in the memory of the devices upon activation of a secondary video recording mode. Whenever user interactions are made by touching the virtual icons or clicking the physical button connected with devices to generate an additional video segment, the secondary video generation method calculates the starting frame and the ending frame. If another user interaction is made before the ending frame, the secondary video generation mode re-calculates the ending frame. The secondary video generation method recalculates the ending frame extending the segment length. If the secondary video generation method receives a user interaction at 0:40 and calculates an initial frame at 0:30 and an ending frame at 0:55, receiving another user interaction during the interval of 0:40 to 0:55 would cause the secondary video generation method to recalculate the ending instance to +0:15 from whenever the newer user interaction was received. The frames are stored in the temp file till the completion of recording the event. When the user completes the recording event, the temp file is converted into the video file.

The secondary video generation method relies on a video recording system that uses Camera(s) and mic(s) to capture the images of events. A touch screen is utilized monitor the image(s) captured by camera(s) and to input the user interactions with the virtual icons on the screen. Memory is to store the video files generated by the processor. Physical button(s) is connected to user input interface directly or to connectivity interface, which covers Bluetooth, WiFi, and other wireless connectivities.

Although the invention has been explained in relation to its preferred embodiment, it is to be understood that many other possible modifications and variations can be made without departing from the spirit and scope of the invention as hereinafter claimed.

What is claimed is:

1. A method of generating a secondary video by executing computer-executable instructions stored on a non-transitory computer-readable medium comprises the steps of:
providing an active video recording system, wherein the video recording system is capturing a primary video recording;
providing the primary video recording comprising a plurality of frames, wherein each frame of the plurality of frames being consecutively assigned a frame value;
providing a system interface, wherein the system interface is an interaction point between a user and the video recording system;
generating a secondary video tempfile in an allocated storage space;
receiving a plurality of segment indentifying inputs through the system interface;
determining an input frame value for each segment identifying input of the plurality of segment identifying inputs, wherein an input frame value marks a frame of the primary video recording;
calculating an initial frame value from the input frame value using an initial frame interval, wherein the initial frame value being less than the input frame value;
calculating an ending frame value from the input frame value using an ending frame interval, wherein the ending frame value being greater than the input frame value;
duplicating frames of the primary video recording associated with a plurality of secondary video segments;
aggregating a plurality of secondary video segments in the secondary video tempfile; and
generating a secondary video recording from the secondary video tempfile.

2. The step of generating the secondary video tempfile by executing computer-executable instructions stored on a non-transitory computer-readable medium in claim 1, wherein the secondary video generation method detects the active video recording system.

3. The method of generating a secondary video by executing computer-executable instructions stored on a non-transitory computer-readable medium as claimed in claim 1 comprises the steps of:
receiving a user input through the system interface;
determining the user input as a segment identifying input;
determining a corresponding frame value of the primary video recording for the segment identifying input; and
identifying the corresponding frame value as the input frame value for the segment identifying input.

4. The method of generating a secondary video by executing computer-executable instructions stored on a non-transitory computer-readable medium as claimed in claim 1 comprises the steps of:
detecting a new input frame value for a new segment identifying input;
calculating a new initial frame value from the new input frame value using the initial frame interval;
calculating a new ending frame value from the new input frame value using the ending frame interval;
duplicating frames of the primary video recording associated with an appended secondary video segment, wherein the appended secondary video segment spans a previous initial frame value to the new ending frame value;
if the new initial frame value is less than or equal to the ending frame value of the previous segment identifying input; and
duplicating frames of the primary video recording associated with a secondary video segment, wherein the secondary video segment spans a previous initial frame value to the previous ending frame value,
duplicating frames of the primary video recording associated with another secondary video segment, wherein the other secondary video segment spans the new initial frame value to the new ending frame value,
if the new initial frame value is greater than the ending frame value of the previous segment identifying input.

5. The step of aggregating the plurality of secondary video segments by executing computer-executable instructions stored on a non-transitory computer-readable medium as claimed in claim 1 comprises the steps of:
receiving the plurality of secondary video segments in the secondary video tempfile, wherein the plurality of secondary video segments comprise secondary video segments spanning from an initial frame value to an ending frame value and appended secondary video segments spanning from an initial frame value to a new ending frame value; and
arranging the plurality of secondary video segments in the secondary video tempfile in successive order.

6. The method of generating a secondary video by executing computer-executable instructions stored on a non-transitory computer readable medium as claimed in claim 1 comprises:
detecting a secondary video generation event; and
converting the secondary video tempfile into the secondary video recording.

7. The method of generating a secondary video by executing computer-executable instructions stored on a non-transitory computer readable medium in claim 6, wherein the secondary video generation event is the completion of the primary video recording.

8. A method of generating a secondary video by executing computer-executable instructions stored on a non-transitory computer-readable medium comprises the steps of:
providing an active video recording system, wherein the video recording system is capturing a primary video recording;
providing the primary video recording comprising a plurality of frames, wherein each frame of the plurality of frames being consecutively assigned a frame value;
providing a system interface, wherein the system interface is an interaction point between a user and the video recording system;
detecting the active video recording system;
generating a secondary video tempfile in an allocated storage space;
receiving a plurality of segment indentifying inputs through the system interface,
determining an input frame value for each segment identifying input of the plurality of segment identifying inputs, wherein an input frame value marks a frame of the primary video recording;
calculating an initial frame value from the input frame value using an initial frame interval, wherein the initial frame value being less than the input frame value;
calculating an ending frame value from the input frame value using an ending frame interval, wherein the ending frame value being greater than the input frame value;
duplicating frames of the primary video recording associated with a plurality of secondary video segments;
receiving the plurality of secondary video segments in the secondary video tempfile, wherein the plurality of secondary video segments comprise secondary video segments spanning from an initial frame value to an ending frame value and appended secondary video segments spanning from an initial frame value to a new ending frame value;
arranging the plurality of secondary video segments in the secondary video tempfile in successive order;
detecting a secondary video generation event; and
converting the secondary video tempfile into a secondary video recording.

9. The method of generating a secondary video by executing computer-executable instructions stored on a non-transitory computer-readable medium as claimed in claim 8 comprises the steps of:
receiving a user input through the system interface;
determining the user input as a segment identifying input;
determining a corresponding frame value of the primary video recording for the segment identifying input; and
identifying the corresponding frame value as the input frame value for the segment identifying input.

10. The method of generating a secondary video by executing computer-executable instructions stored on a non-transitory computer-readable medium as claimed in claim 8 comprises the steps of:
detecting a new input frame value for a new segment identifying input;
calculating a new initial frame value from the new input frame value using the initial frame interval;
calculating a new ending frame value from the new input frame value using the ending frame interval;
duplicating frames of the primary video recording associated with an appended secondary video segment, wherein the appended secondary video segment spans a previous initial frame value to the new ending frame value;
if the new initial frame value is less than or equal to the ending frame value of the previous segment identifying input; and
duplicating frames of the primary video recording associated with a secondary video segment, wherein the secondary video segment spans a previous initial frame value to the previous ending frame value,
duplicating frames of the primary video recording associated with another secondary video segment, wherein the other secondary video segment spans the new initial frame value to the new ending frame value,
if the new initial frame value is greater than the ending frame value of the previous segment identifying input.

11. The method of generating a secondary video by executing computer-executable instructions stored on a non-transitory computer readable medium in claim 8, wherein the secondary video generation event is the completion of the primary video recording.

12. A method of generating a secondary video by executing computer-executable instructions stored on a non-transitory computer-readable medium comprises the steps of:
providing an active video recording system, wherein the video recording system is capturing a primary video recording;
providing the primary video recording comprising a plurality of frames, wherein each frame of the plurality of frames being consecutively assigned a frame value;
providing a system interface, wherein the system interface is an interaction point between a user and the video recording system;
detecting the active video recording system;
generating a secondary video tempfile in an allocated storage space;
receiving a plurality of segment indentifying inputs through the system interface,
determining an input frame value for each segment identifying input of the plurality of segment identifying inputs, wherein an input frame value marks a frame of the primary video recording;
calculating an initial frame value from the input frame value using an initial frame interval, wherein the initial frame value being less than the input frame value;
calculating an ending frame value from the input frame value using an ending frame interval, wherein the ending frame value being greater than the input frame value;
calculating a new initial frame value from the new input frame value using the initial frame interval,
calculating a new ending frame value from the new input frame value using the ending frame interval,
if a new input frame value for a new segment identifying input is detected;
duplicating frames of the primary video recording associated with a secondary video segment, wherein the secondary video segment spans the initial frame value to the ending frame value,
if no new input frame value is detected;
duplicating frames of the primary video recording associated with an appended secondary video segment, wherein the appended secondary video segment spans a previous initial frame value to the new ending frame value;
if the new initial frame value is less than or equal to the ending frame value of the previous segment identifying input;
duplicating frames of the primary video recording associated with a secondary video segment, wherein the secondary video segment spans a previous initial frame value to the previous ending frame value,
duplicating frames of the primary video recording associated with another secondary video segment, wherein the other secondary video segment spans the new initial frame value to the new ending frame value,
if the new initial frame value is greater than the ending frame value of the previous segment identifying input;
aggregating a plurality of secondary video segments in the secondary video tempfile, wherein the plurality of secondary video segments comprise secondary video segments and appended secondary video segments;
arranging the plurality of secondary video segments in the secondary video tempfile in successive order;
detecting deactivation of video recording system, wherein the deactivation of the video recording system occurs upon completion of the primary video recording; and
converting the secondary video tempfile into a secondary video recording.

13. The method of generating a secondary video by executing computer-executable instructions stored on a non-transitory computer-readable medium as claimed in claim 12 comprises the steps of:
receiving a user input through the system interface;
determining the user input as a segment identifying input;
determining a corresponding frame value of the primary video recording for the segment identifying input; and
identifying the corresponding frame value as the input frame value for the segment identifying input.
